(19) United States
(12) Patent Application Publication
(10) Pub. No.: US 2004/0028080 A1
(43) Pub. Date: Feb. 12, 2004

(54) Method of defining a SIP message body for communications between core network elements

(76) Inventors: Harish Samarasinghe, Holmdel, NJ (US); Robert Yeager Peters JR., Rumson, NJ (US)

Correspondence Address: Robert V. Klauzinski, Daly, Crowley & Mofford, LLP, Suite 101, 275 Turnpike Street, Canton, MA, 02021-2310, US

(21) Appl. No.: 10/384,223

(22) Filed: Mar. 7, 2003

Related U.S. Application Data
(60) Provisional application No. 60/401,376, filed on Aug. 6, 2002.

(51) Int. Cl. H04L 12/56

(52) U.S. Cl. 370/486; 370/389

(57) ABSTRACT

A Session Initiation Protocol (SIP) request message and a SIP response message which are each adapted for communication between a plurality of network elements located on a multi-media services provider system for processing requests for multi-media services. The SIP request message includes a header region and a body region. The body region of the SIP request message can include a number of information parameters, such as, a border element identifier, a charge number parameter, a local address and transport area, a carrier, a calling party number, a charge party station type and a collected address. The SIP response message also includes a header portion and a body portion. The body portion of the SIP response message includes a number of service specific information parameters, such as a collected address, primary and alternate routing addresses, an alternate routing condition, manipulated digits and recording instructions.

### CROSS-REFERENCE TO RELATED APPLICATION

This application claims the benefit under 35 U.S.C. §119(e) of U.S. Provisional Application Serial No. 60/401,376, filed Aug. 6, 2002, entitled, METHOD OF DEFINING SIP MESSAGE BODY FOR COMMUNICATIONS BETWEEN CALL CONTROL ELEMENT AND OTHER NETWORK ELEMENTS.

### FIELD OF THE INVENTION

The present invention relates generally to SIP messages, which are adapted to efficiently communicate information between a number of network elements of a communication system, and more specifically, to SIP messages, which include a body portion containing parameters related to the originating party (e.g. calling party), terminating party (e.g. called party), and/or service specific information elements (e.g. routing instructions and billing instructions).

### BACKGROUND

Presently, SIP is becoming an increasingly popular protocol for transporting both standard and non-standard information in a common framework over Internet Protocol (IP) based Local Area Networks (LANs), such as systems and services provided by AT&T. However, one drawback to the present SIP protocol is that the headers of SIP messages do not define a standard way to convey information, which is required to support the most common multi-media advanced intelligent features, such as, virtual private network with account code/authorization validation and alternate routing. Since the SIP protocol and associated SIP messages do not define the parameters needed to support the multi-media advanced features, SIP cannot provide a standard way for signaling multi-media feature information between core network elements of the IP-based LAN.

The drawback to the present SIP protocol is further exasperated in that the SIP protocol does not provide any SIP signaling messages that are adapted to carry multi-media processing related information, such as, a charge number, local access and transport area (LATA), carrier, billing and other information required for multi-media service processing. Therefore, an unsolved need remains for a SIP protocol that provides SIP signaling messages, which are adapted for carrying multi-media processing related information necessary for providing signaling between core network elements of the IP-based LAN.

### SUMMARY OF THE INVENTION

In one aspect of the present invention, set forth is a method of forming a multi-media communication path between at least a calling communication device and at least a destination communication device. The method includes receiving a request for a multi-media service at a multi-media provider system. The call request is processed at the multi-media provider system for generating a Session Initiation Protocol (SIP) INVITE message. The SIP INVITE message can be sent to at least one processor of the multi-media provider system for processing the request for the multi-media service. The SIP INVITE message may include at least one body portion having at least one information element required for providing call processing and service processing for the request for the multi-media service.

In one aspect, processing the call request at the multi-media provider system may include processing the call request at a border element located on the multi-media provider system. Alternatively, processing the call request at the multi-media provider system may include processing the call request at a call control element located on the multi-media provider system.

In one aspect, generating the SIP INVITE message includes providing border element identifier information in the at least one body portion of the SIP INVITE message. In addition, generating the SIP INVITE message may include providing a plurality of other information in the at least one body portion of the SIP INVITE message, such as: charge number related information; local access and transport area related information; carrier related information; calling party number related information; charge party station type related information; Customer Identifier related information; and collected address related information.

The method further includes processing the SIP INVITE message at the processor for generating a SIP Redirect message. The SIP Redirect message is thereafter sent to the call control element. The SIP Redirect message includes at least one body portion having at least one information element required for providing call processing and service processing of the multi-media service request.

In one aspect, generating the SIP Redirect message includes providing a collected address parameter in the at least one body portion of the SIP Redirect message. In addition, generating the SIP Redirect message may include providing a plurality of other information in the at least one body portion of the SIP Redirect message, such as: a primary routing address parameter; an alternate routing address parameter; an alternate routing condition parameter; a manipulated digits parameter; a Carrier Identification Code parameter; a Carrier Usage parameter; a recording instruction parameter; and a recording information parameter;

In one aspect of the present invention, set forth is a Session Initiation Protocol (SIP) message adapted for communication between a plurality of network elements to form a multi-media communication path between at least a calling communication device and at least a destination communication device. The SIP message includes a header portion and a body portion. The body portion includes at least one information element required for providing call processing and service processing for at least one request for at least one multi-media service.

In one aspect, the SIP message can include a SIP INVITE message. The body portion of the SIP INVITE message can further include a plurality of other information, such as: a border element identifier information; charge number related information; local access and transport area related information; carrier related information; calling party number related information; charge party station type related information; collected address related information; Customer Identifier parameter; a Test Query parameter

In another aspect, the SIP message can include a SIP Redirect message. The body portion of the SIP Redirect message can further include a plurality of other information, such as: a collected address parameter; a primary routing address parameter; an alternate routing address parameter; an alternate routing condition parameter; a manipulated digits parameter; a Carrier Identification Code parameter; a Carrier Usage parameter; a recording instruction parameter; a recording information parameter; a Session Gapping parameter; and an Error Description parameter.

### BRIEF DESCRIPTION OF THE DRAWING

The foregoing and other objects of this invention, the various features thereof, as well as the invention itself, can be more fully understood from the following description, when read together with the accompanying drawings in which:

FIG. 1 is an exemplary high-level schematic block diagram of a system for providing multi-media communications between a plurality of communication devices according to the present invention; and

FIG. 2 is an expanded schematic block diagram of the system shown in FIG. 1.

### DETAILED DESCRIPTION OF THE INVENTION

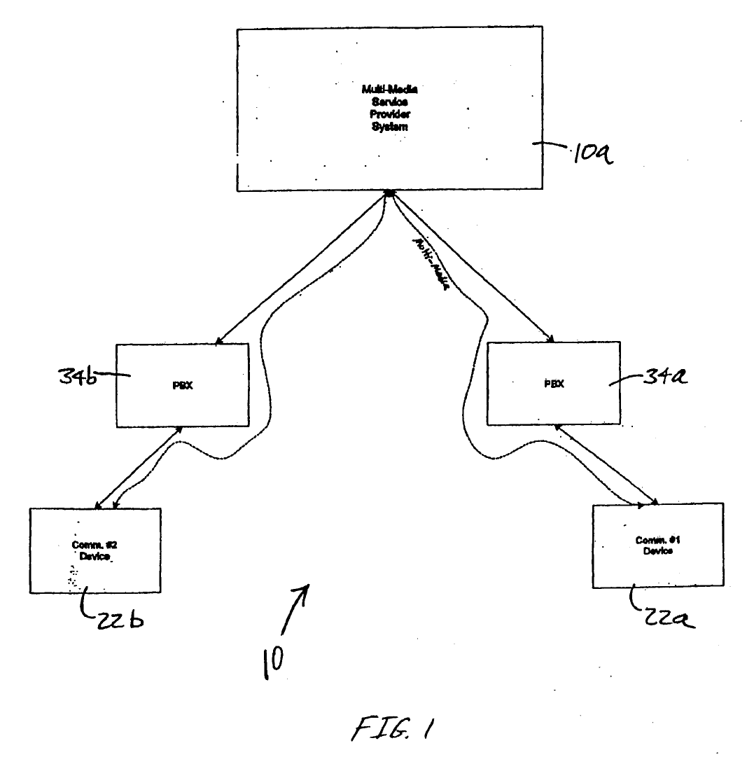

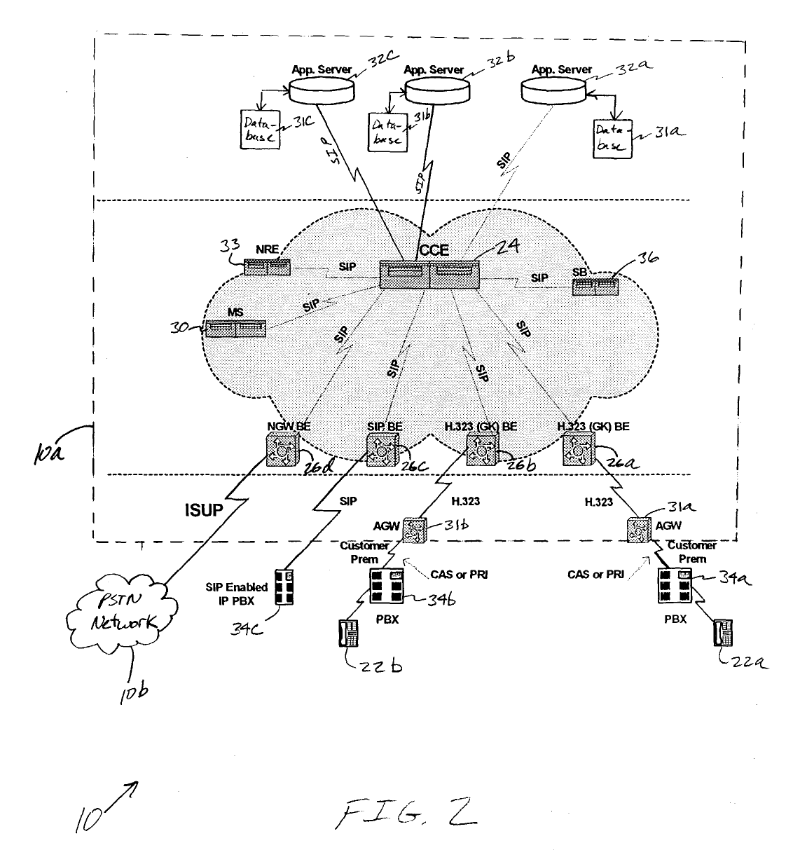

In accordance with principles of the present invention, set forth are SIP messages (e.g. INVITE or Redirect), which each include predetermined content and format for communicating information between various elements of a communications system, such as the multi-media services provider system 10a, as described below in connection with FIGS. 1 and 2. The INVITE message may be further adapted to communicate information between the multi-media services provider system 10a and other various external network devices.

Referring to FIG. 1, shown is one embodiment of a communication network. 10 for providing multi-media communications between at least first 22a and second 22b communication devices of a plurality of communication devices, in accordance with the present invention. The communication network 10 includes a multi-media provider system 10a, which is operative to provide a plurality of multi-media services to the first 22a and second 22b communication devices, via respective first 34a and second 34b SIP-enabled IP-Private Branch Exchanges (hereinafter referred to as “PBXs”). It should be understood that the multi-media services provider system 10a is additionally operative to provide a plurality of multi-media services to a plurality of other communication devices not specifically shown herein.

Referring to FIG. 2, in the exemplary embodiment, the multi-media services provider system 10a includes a centrally located Call Control Element 24 (CCE), a Media Server (MS) 30, a plurality of Application Servers (ASs) 32a, 32b, 32c (collectively referred to hereinafter as ASs 32a-32b), at least one Network Routing Engine (NRE) 33, at least one Service Broker (SB) 36 and a plurality of Border Elements (BEs) 26a, 26b, 26c, 26d (collectively referred to hereinafter as BEs 26a-26d). The CCE 24 is coupled to the plurality of ASs 32a-32c, to the plurality of BEs 26a-26d and to the MS 30. The CCE 24 is further coupled to the NRE 33 and to the SB 36.

In the exemplary embodiment, the plurality of BEs 26a-26d are adapted to use SIP as the signaling protocol for interfacing with the CCE 24. In addition, the first BE 26a is coupled to the first communication device 22a, via a first access gateway 31a and the first PBX 34a. The first BE 26a is also adapted to operate using an H.323 protocol for interfacing to the first access gateway 31a. The second BE 26b is coupled to the second communication device 22b, via a second access gateway 31b and the second PBX 34b. The second BE 26b is also adapted to operate using the H.323 protocol for interfacing to the second access gateway 31b. The third BE 26c is coupled to the third PBX 34c and is adapted to use SIP for interfacing to the PBX 34c. The fourth BE 26d is coupled to a Public Switched Telephone Network (PSTN) 10b and is adapted to operate using Integrated Services Digital Network User Part (ISUP) as a protocol for interfacing to the PSTN 10b. It should be understood that the BEs 26a-26d can be coupled to a plurality of other access gateways, PBXs and/or communication devices, which are included in other embodiments not specifically shown herein.

The CCE 24, for example, can be provided by Lucent Corporation of Murray Hill, N.J. The CCE 24 may be defined as a back-to-back user agent (B2BUA), which operates to receive a plurality of INVITE messages from any one of the plurality of BEs 26a-26d and upon receipt of the plurality of INVITE messages from the plurality of BEs 26a-26d, the CCE 24 can initiate an equal plurality of INVITE messages to the SB 36. The CCE 24 is further adapted to receive a plurality of Redirect messages from the SB 36 in response to the plurality of INVITE messages sent to the SB 36 from the CCE 24. When the CCE 24 receives a Redirect message back from the SB 36 in response to an INVITE message and depending on instructions provided by the SB 36 in the Redirect message, the CCE 24 can either send an INVITE message to one or more of the plurality of ASs 32a-32c for feature processing for the call or the CCE 24 can send an INVITE message to the NRE 33 (i.e. feature processing is not required for the call) to bypass the plurality of ASs 32a-32c and set up the call. The CCE 24 is further adapted to maintain the call state between the first 22a and the second 22b communication devices and to generate a call detail record (CDR) based on instructions received from any one or more of the plurality of ASs 32a-32c.

The CCE 24 is also adapted to use “Third Party Call Control,” which is described in the reference, “Third Party Call Control in SIP” by Rosenberg, Peterson, Schulzrinne, Camarillo, RFC-Draft, Internet Engineering Task Force, Mar. 2, 2001,” which is herein incorporated by reference. The Third Party Call Control feature of the CCE 24, permits the CCE 24 to create a call in which communication is actually between other parties. For example, an operator can use Third Party Call Control to create a call that connects two participants together or similarly, the CCE 24 can use Third Party Call Control to connect the MS 30 and the first communication device 22a. Generally, Third Party Call control allows the CCE 24 to connect the various end callers without having the media stream pass through the CCE 24 and yet, the CCE 24 can still maintain call state information.

In the exemplary embodiment, the plurality of BEs 26a-26d can be provided by Lucent Corporation of Murray Hill, N.J. Further, the plurality of BEs 26a-26d may be thought of as a B2BUA because each of the BEs 26a-26d generates SIP messages as well as receives requests from various communication devices, such as the first 22a and second 22b communication devices, and either processes the requests itself or forwards the requests to the CCE 24 for processing.

In the exemplary embodiment, the SB 36 can also be provided by Lucent Corporation of Murray Hill, N.J. In one embodiment, the SB 36 acts as the SIP Redirect Server. The SB 36 operates to identify a particular service request, which is included in the INVITE message received at the SB 36 from the CCE 24. The SB further operates to instruct the CCE 24, via a Redirect message, to redirect the call to one or more of the plurality of ASs 32a-32c for service processing. In an embodiment, the SB 36 can identify a particular service requested by the call based on Charge Number or Collected Address information included in the INVITE message received at the SB 36 from the CCE 24. In addition, the SB 36 may perform call screening based on other information elements like the Charge Party Station Type (a.k.a. OLI-Originating Line Information), Carrier Identification Code (CIC), Border Element ID, among others, received in the INVITE message at the SB 36.

After the SB 36 determines which of the first AS 32a, second AS 32b or third AS 32c as the primary and secondary processors for processing a particular call request, the SB 36 generates a SIP Redirect “300 Multiple Choice” message and populates any required service specific parameters such as the IP address/Port number combinations of the (primary/secondary) AS 32a, 32b or 32c in the Contact headers and Customer ID and Service Type parameters in the Body of the “300 Multiple Choice” message, and sends it to the CCE 24. This approach permits the CCE 24 to query the secondary AS 32a, 32b or 32c in the event that the primary AS 32a, 32b or 32c is overloaded or not available to process the call request. If the SB 36 does not find a Charge Number or Collected Address match in the INVITE message received from the CCE 24, but has a carrier other than the multi-media service provider system 10a (e.g. AT&T), the SB 36 may send another SIP Redirect “300 Multiple Choice” to the CCE 24 with the IP address of the NRE 33 indicating that the call request does not require AS 32a-32c processing, which effectively bypasses any service processing at the plurality of ASs 32a-32c.

In the exemplary embodiment, the plurality of ASs 32a-32c can each include a conventional computer server, such as an “NT-Server,” which can be provided by Microsoft of Richmond, Wash. or a “Unix Solaris Server,” which can be provided by Sun Micro Systems of Palo Alto, Calif. The ASs 32a-32c can be programmed with conventional Web-page interface software such as: “Visual Basic,” “Java,” “JavaScript,” “HTML/DHTML,” “C++,” “J+,” “Perl,” or “Perlscript,” and “ASP.” The ASs 32a-32c can each further be programmed with an operating system, Web server software and Web Application software, such as an e-commerce application and computer network interface software.

In addition, the ASs 32a-32c contain the intelligence needed for offering multimedia services such as Toll-Free Calling or 800-Service, Virtual Private Networks, and various multimedia features like email, “Click-To-Dial.” The intelligence may be comprised of customer logic and data, as well as, common logic and data that are used by all customers. It is necessary for the CCE 24 to access the logic and data in the ASs 32a-32c in order to provide the multi-media services or features.

The ASs 32a-32c can each be further respectively coupled to databases 31a-31c, which each contain a service intelligence layer adapted for providing the plurality of multi-media services described above. The intelligence layer may include customer logic and data, as well as common logic and data that is used by communication devices 22a, 22b, as well as a plurality of other communication devices not specifically shown in FIG. 2.

The NRE 33 also operates as a SIP Redirect Server. The NRE 33 processes INVITE messages received from the CCE 24; performs address resolution based on the routing number returned from the AS 32a-32c and generates a Redirect “300 Multiple Choice” message. The NRE 33 populates Redirect 300 Multiple Choice message with the IP addresses of one or more destination BEs 26a-26d and sends the Redirect 300 Multiple Choice message to the CCE 24. In an embodiment, the NRE 33 can send the Redirect 300 Multiple Choice message to the CCE 24 with a predetermined hierarchical list of IP addresses corresponding to a predetermined hierarchical order of BEs 26a-26d for processing the call. In this arrangement, a highest level BE 26a, 26b, 26c or 26d defined on the list can receive and process the call and if the highest level BE 26a, 26b, 26c or 26d is unable to process the call or has insufficient resources to do so, the call may be redirected by the CCE 24 to a next successive BE 26a, 26b, 26c or 26d.

In the exemplary embodiment, the first 22a and second 22b communication devices can include a plurality of H.323 or SIP-enabled devices, such as telephones, personal computers and IP-Private Branch Exchanges (“PBXs”). In addition, the first 22a and second 22b communication devices can include a plurality of H.323 or SIP-enabled wireless devices, such as cellular telephones, pagers and personal digital assistants (“PDAs”).

The MS 30 of the exemplary embodiment, is constructed and arranged to provide a plurality of predetermined announcements to the communication devices 22a, 22b and to collect information from the communication devices 22a, 22b (e.g. caller-entered data). For example, if the caller is required to enter digits or a phrase for a Call Prompter service or SDN (Software Defined Network) service, the MS 30 will play the announcement prompting the caller to enter the required information. The MS 30 also collects the information entered by the caller. The MS 30 plays the announcements to the caller based on the instructions and announcement ID provided in the second INVITE message. In one embodiment, the announcements can include “Service Terminating” announcements or announcements for the caller to enter an authorization code, account code, or “call-prompter” digits.

In an exemplary embodiment, the MS 30 can be defined as a VoiceXML based MS 30. The MS 30 provides various announcements and collects various information from callers operating from communication devices 22a or 22b when features requiring caller interaction are required to complete a call. For example, if the caller must enter digits or a phrase for a Call Prompter service or SDN service, which can be provided by the multi-media services provider system 10a, the MS 30 will play the announcement prompting the caller to enter the required information. The MS 30 further collects the information entered by the caller, which is defined herein as “caller-entered data.”

As described above, the CCE 24 is adapted to receive a call request or INVITE message from the first 22a and/or second 22b communication devices, which requests multi-media services. In response, the CCE 24 can communicate with any one or more of the SB 36, the plurality of application servers 32a-32c, the NRE 33 and/or the plurality of BEs 26a-26d using a number of INVITE messages.

An INVITE message may be generated by the CCE 24 and communicated to one or more of the plurality of application servers 32a-32c and can include the information shown in the exemplary embodiments, which will be described in detail below. Also, an INVITE message may be generated by the BEs 26a-26d, which can be communicated to the CCE 24 and which can include predetermined information, as also described in the exemplary embodiments below.

In one exemplary embodiment, an INVITE message generated by the CCE 24 and communicated to one or more of the plurality of application servers 32a-32c can include the following information:

INVITE sip:7324204734@sdnas.att.com;user=phone SIP/2.0
Via: SIP/2.0/UDP att.com:5060
Max-Forwards: 20
From: sip:7324204699@att.com
To: <sip:7324204734@att.com>
Call-ID: c39h4563-d119a-2995c 2e322238@att.com
CSeq: 100 INVITE
Accept: application/vnd.att-advanced-intelligent-services
Contact: sip:7324204699@att.com:5060
Content-Type: application/vnd.att-advanced-intelligent-services;
boundary=“- -
att advanced services - -”
Content-Disposition: session
Content-Length: nnn
- - att advanced services
BEID = be.mtnj.1234CN = 7324204699;3;1
CID = 8880001234
L = 222
C = 0288;0
CPN = 7324204699;3;1;0;3
CPST = 3
CA = 7324204734;3;1
- - att advanced services - -

The exemplary embodiment of the INVITE message includes a headers portion having a number of header fields and a body portion having a number of body parameters. The header fields of the INVITE message can include: INVITE sip, Via, Max-Forwards, From, To, Call-ID, CSeq, Accept, Contact, Content-Type, Content-Disposition and Content-Length. In addition, the body parameters of the INVITE message can include: Border Element Identification (BEID), Charge Number (CN), Customer ID (CID), Local Access and Transport Area (LATA) or (L), Carrier (C), Calling Party Number (CPN), Charge Party Station Type (CPST) and Collected Address (CA), which will each be described in further detail below.

The body parameters of the INVITE message follow a name value pair convention. This allows the parameters to be placed in any order in the body portion of the INVITE message. Furthermore, a number of the body parameters follow a format that closely resembles signaling standards defined by the American National Standards Institute (ANSI). This facilitates inter-working between the SIP-based IP network and the ANSI-based or PSTN-based circuit network 10b. In addition, using this format facilitates the transition from network elements and support systems that are based on ANSI-based standards.

The body parameters of the INVITE message can be encoded using a number of formats to permit efficient use on the multi-media services provider system 10a, as well as, on a number of other multi-media services provider systems not specifically shown herein. In the exemplary embodiment, the body parameters of the INVITE message are encoded using an ASCII format to assist in understanding and appreciation of principles of the present invention, however, it should be understood that other encoding formats can be used, such as a binary format or an XML format to encode the body parameters of the SIP messages.

It should also be understood that many other conventions and/or names, which are associated with each of the parameters of the SIP messages, can be employed for carrying service specific information in the body of the SIP messages. For example, the Charge Number can be named an Automatic Number Identification (ANI) and the Collected Address parameter can be named a Dialed Number parameter.

The BEID parameter (e.g. Border Element Identification) of the body portion of the SIP message may be used to identify which of the plurality of BEs 26a-26d originated the call by sending the INVITE message to the CCE 24. In an embodiment, the BEID parameter includes a string of 8 to 16 non-escape characters, which can be case sensitive. The format of the BEID parameter should follow a naming convention for which the type of BE 26a-26d (e.g. SIP, H.323 or ISUP) may be determined. For example, the first BE 26a, which is adapted to operate using the SIP and/or H.323 protocols, should follow a naming convention, such as, bemtnj.att.com. The naming convention of bemtnj.att.com identifies the first BE 26a as a nodal access element. In another example, the fourth BE 26d, which is adapted to operate using the SIP and/or ISUP protocols, should follow a naming convention, such as, ngbdnj.att.com. The naming convention of ngbdnj.att.com identifies the fourth BE 26d as a switched access element. In another embodiment, the BEID may simply be the IP address of the originating BE 26a-26d.

The CN parameter (e.g. Charge Number) of the body portion of the SIP message may contain the charge number of the calling communication device, such as the first communication device 22a. The CN parameter may be set by the CCE 24, BE 26a-26d, and/or the plurality of ASs 32a-32c. The format of the CN closely resembles the signaling standard format used by ANSI, which as described above, facilitates inter-working between the SIP-based multi-media provider system 10a and the ANSI-based or PSTN-based circuit network 10b.

The Customer ID (CID) parameter of the body portion of the SIP message identifies the specific customer account containing the data and logic used to provide the features specific to the customer. In an embodiment, the CID parameter may be a 10 digit number (e.g. 8880001234).

The LATA parameter (e.g. Local Access and Transport Area) of the body portion of the SIP message may contain the local access and transport area related information associated with the calling communication device, such as the first communication device 22a. The LATA parameter may be set by network elements, such as the first access gateway 31a, CCE 24 or the ASs 32a-32c. In an embodiment, the LATA parameter can be a three digit number (e.g. 291).

The C parameter (e.g. Carrier) of the body portion of the SIP message may contain carrier information related to the session and/or call. The C parameter information may be defined in the body portion of the INVITE message by the calling or first communication device or the C parameter information may be set by one of the network elements located on the multi-media provider system 10a, such as the CCE 24 or the AS 32a-32c.

In an exemplary embodiment, the C parameter follows the following format:

Carrier Selection:
0 = No indication
1 = Selected carrier identification code pre-subscribed and not input by
calling party
2 = Selected carrier identification code pre-subscribed and input by calling
party
3 = Selected carrier identification code pre-subscribed, no indication of
whether input by calling party
4 = Selected carrier identification code not pre-subscribed and input by
calling party
Carrier Digits:
A 4 digit integer.
Nature of Carrier:
0 = No Nature of Carrier Provided
1 = Local
2 = IntraLATA toll
3 = InterLATA
4 = Local, intraLATA toll and interLATA
5 = Local and intraLATA toll
6 = IntraLATA toll and interLATA

Although not specifically shown, the body portion of the SIP message can also include a Carrier Usage (CU) parameter. The CU parameter is returned to indicate how the C parameter, as described above, should be used. The CU parameter may contains one of the following values:

0=Always Override

1=Only InterLATA Override

2=Override PICS of NOCs Sent

The CPN parameter (e.g. Calling Party Number) of the body portion of the SIP message may contain a charge number associated with the calling or first communication device. The CPN parameter follows the SIP-Digits format, which closely resembles the format used by ANSI signaling standards, which facilitates inter-working between the SIP-based multi-media services provider system 10a and the ANSI-based or PSTN-based circuit network 10b. If, however, the first PBX 34a associated with the calling or first communication device 22a uses integrated services digital network (ISDN) to connect to the first BE 26a, the CPN parameter may be different than the charge number. Furthermore, the CPN may be set by one of the network elements located on the multi-media provider system 10a, such as the CCE 24, BE 26a-26d, or the AS 32a-32c. The CPST parameter (e.g. Charge Party Station Type) of the body portion of the SIP message may contain information related to physical attributes of the calling party station or first communication device 22a, such as whether the first communication device is a pay phone, hotel phone, etc. The CPST parameter can also be referred to as Originating Line Information (OLI) within the ISUP protocol. In an embodiment, the CPST parameter can include the following information:

0=Identified Line—No Special Treatment

1=ONI (Multiparty)

2=ANI Failure (unavailable)

3=Hotel (without room identification)

4=Coinless, Hospital, Inmate, etc.

5=InterLATA Restricted

6=AIOD—Listed DN sent

7=Identified Line (coin or no coin)

8=Coin call

9=AIN

10=InterLATA restricted—Hotel line

11=InterLATA restricted—Coinless line, etc.

12=Test Call

The CA parameter (e.g. Collected Address) of the body portion of the SIP message may contain address related information of the destination communication device, such as the second communication device 22b, for which the calling party operating at the first communication device is trying to contact. In telephony terms, the address related information related to the second communication device 22b contains the dialed number (DN), the Collected Address Information or the Called Party Number. The CA parameter of the body portion of the SIP message follows the SIP-Digits format and resembles the format used by ANSI signaling standards, which facilitates inter-working between the SIP-based IP network and the ANSI-based circuit network.

Although not shown in the exemplary body portion of the INVITE message, the body portion of the INVITE message can further include a Test Query (TQ) parameter. The TQ parameter is only included in the INVITE message during test queries and provides an indication to the CCE 24 to perform special call trace and reporting functions, as predefined in the CCE 24. In one exemplary embodiment, the test query can include the following value: 0=Test Session.

Furthermore, although not shown in the exemplary body portion of the INVITE message, the body portion of the INVITE message can further include a Caller Name parameter. The Caller Name parameter contains the caller name of the originating or calling party. The Caller Name parameter may include a string of up to 16 non-escape characters, which can be case sensitive.

After processing the above-described INVITE message at one or more of the plurality of application servers 32a-32c, the one or more of the plurality of application servers 32a-32c can send the CCE 24a Redirect message instructing the CCE 24 to set up the call request. In one exemplary embodiment, the Redirect message generated by one or more of the plurality of application servers 32a-32c and received by the CCE 24 can include the following information:

SIP/2.0 300 Moved
Contact: sip: 7324204734@nre.att.com
Via: SIP/2.0/UDP att.com:5060
From: sip:7324204699@att.com
To: <sip:7324204734@att.com>
Call-ID: c39h4563-d119a-2995c 2e322238@att.com
CSeq: 100 INVITE
Accept: application/vnd.att-advanced-intelligent-services
Contact: sip:7324204699@att.com:5060
Content-Type: application/vnd.att-advanced-intelligent-services;
boundary=“- -
att advanced services - - ”
Content-Disposition: session
Content-Length: nnn
- - att advanced services - -
CN = 7324204699;3;1
L = 222
C = 0;0288;0
CU = 1
CPN = 7324204699;3;1;0;3
CPST = 3
CA = 7324204734;3;1
PRA = 4204734;5;1
ARA = 7326710101;3;1
ARC = 408, 486
MD = 6549
INS = 0
INF =
999000123;
878c045c1c876c00000cfffff827c008c1c010c0007324204000;129
- - att advanced services - -

The Redirect message can include a header portion having a number of header fields, which are similar to the INVITE message and a body portion having a number of service related parameters. The header fields defined in the header portion of the Redirect message can include, Contact: sip, Via, From, To, Call-ID, Cseq, Accept, Contact, Content-Type, Content-Disposition and Content-Length. The header fields of the Redirect message are similar to the header fields of the INVITE message and also follow the ANSI standard signaling formats.

The service related parameters defined in the body portion of the Redirect message can include, CN, L, C, CU, CPN, CPST and CA, which are similar to the CN, L, C, CU, CPN, CPST and CA parameters described above with respect to the INVITE message and each respective parameter includes similar information (e.g. similar digits). The body portion of the Redirect message can include additional service related parameters, such as, Primary Routing Address (PRA), Alternate Routing Address (ARA), Alternate Routing Condition (ARC), Manipulated Digits (MD) and Recording Instructions and Information (R), which will each be described in further detail below.

The PRA parameter (e.g. Primary Routing Address) of the body portion of the Redirect message may contain the primary routing number, which is associated with the destination or second communication device 22b, for setting up the call. Usually the AS 32a, 32b or 32c sets the PRA parameter based on the application logic and customer features, which are predefined at the AS 32a, 32b or 32c that is processing the call. The format of the PRA parameters follows the SIP-Digits format, which closely resembles the format used by ANSI signaling standards, thereby facilitating inter-working between the SIP-based multi-media services provider system 10a and the ANSI-based or PSTN-based circuit network 10b.

The ARA parameter (e.g. Alternate Routing Address) of the body portion of the Redirect message may contain alternate routing number(s) for routing the call to an alternate destination communication device (not shown). The AS 32a, 32b or 32c sets the ARA parameter based on the application logic and customer features. The format of the ARA parameter also follows the SIP-Digits format and closely resembles the format used by ANSI signaling standards, which facilitates inter-working between the SIP-based multi-media service provider system 10a and the ANSI-based or PSTN-based circuit network 10b.

It should be understood that the NRE 33 may also provide the alternate route(s) with a function like a route advance list or an AS 32a, 32b or 32c may provide an alternate routing address. The NRE 33 can set the ARA parameter by taking the number returned by the AS 32a, 32b or 32c and translating it to one or more network IP addresses. The AS 32a, 32b or 32c can set the ARA parameter based on the application logic and customer features.

The ARC parameter (e.g. Alternate Routing Condition) of the body portion of the Redirect message may contain one or more conditional parameters, which should be satisfied prior to the CCE 24, for example, using the alternate routes provided by either the NRE 33 or AS 32a, 32b or 32c for routing the call request to the destination or second communication device 22b. If there is more than one conditional parameter included in the ARC parameter, the conditional parameters are each separated by a comma. For example, if the AS 32a sends an ARC parameter to the CCE 24, which includes the conditional parameter “486 Busy Here” and the primary routing address results in a “486 Busy Here” signal, the CCE 24 will send an INVITE message to the destination or second communication device 22b by setting the Universal Resource Identifier (URI) to the number indicated in the ARA. In an exemplary embodiment, the ARC parameter can include one or more of the following values, which have the corresponding definitions, as shown below:

408=Request timeout

480=Temporarily Not available

486=Busy Here

502=Bad Gateway

503=Service Unavailable

504=Gateway Time-out

The MD parameter (e.g. Manipulated Digits) of the body portion of the Redirect message may contain the digits that must be out-pulsed to a SIP/H.323 Border Element, such as BE 26b, after performing a Delete/Prefix operation on the called party number in the INVITE message. The AS 32a, for example, can return the MD parameter to the CCE 24, via the Redirect message, for which the CCE 24 packages into the INVITE message which is sent to the destination or second communication device 22b. In one embodiment, the format of the MD parameter is a string of digits. In this embodiment, the format of the MD parameter does not follow the SIP-digits format, which is predicated on the ANSI signaling standard, because the Nature of Number and Numbering Plan Type are not delivered to the destination or second communication device 22b. Rather, the MD parameter is delivered to second communication device, 22b, as a string of digits.

The INS parameter (Recording Instructions) and INF parameter (Recording Information) of the body portion of the Redirect message may contain instructions and information related to recording the call. In an exemplary embodiment, the AS 32a might set the INS parameter to instruct the CCE 24 to record the call based on the charge number. The format of the INS parameter might be defined as:

0=Record Call with Charge Number

1=Record Call with Primary Routing Address

2=Record Call with Alternate Charge Number

In an exemplary embodiment, the AS 32a might set the INF parameter to the Charge Number and Primary Routing Address used for recording. The format of the INFparameter can include the formats and corresponding definitions, as shown below:

AMAslpID = Contains a 9 digit integer
AMABafModules = Contains AMA (Automatic Message Accounting)
data in one or more Billing AMA Format modules. This field follows the
AMABAF Module format as defined in GR-1100-Core, Billing Automatic
Message Accounting Format (BAF) Requirements.
AMA Call Type = Contains a 3 digit number as follows:
309 = Megacom/PCP
129 = SDN
898 = Tollfree
Service Feature ID = Contains a 3 digit number as follows:
045 = Megacom/PCP

The use of the INS and INF parameters are defined by the specific network elements requirements (e.g specific requirements of the CCE 24, ASs 32a-32c, NRE 33 or SB 36).

Although not shown in the exemplary embodiment, the Redirect message can further include an Instruction and Information field having an Error Description parameter (ED). The ED parameter contains additional information on any error scenarios that may exist. In one embodiment, the ED parameter contains a text string having up to 50 characters. For example, if the AS 32a cannot find a customer record for the incoming Charge Number, the AS 32a can return a “503 Service Unavailable” message with the terms ED=Customer Record Not Found.

In addition, although not shown in the exemplary embodiment, the Redirect message can also include a Session Gapping (SG) parameter. The SG parameter provides instructions to the CCE 24 or BE 26 to regulate the flow of the INVITE messages into the multi-media provider system 10a and to regulate the flow of INVITE messages between the various elements of the multi-media provider system 10a, such as between the CCE 24 and one or more of the ASs 32a-32c. In an exemplary embodiment, the SG parameter includes the formats and corresponding definitions, as shown below:

Effected CN=This field contains the Charge Number to control. This field may be blank if either the Effected CA field or Effected AS Address field is non-blank. This field follows the SIP-digits format.

Effected CA=This field contains the Collected Address to control. This field may be blank if either the Effected CN or Effected AS 32a-32c Address field is non-blank. This field follows the SIP-digits format.

Effected AS Address=This field contains the IP address of the AS 32a-32c to control. This field may be blank if either the Effected CN or Effected CA is non-blank.

Gap Duration=This field contains the time duration for applying the control. The possible values of the exemplary embodiment include:

Duration
(in seconds)

10
30
60
90
180
240
300

Gap Interval=This field contains the interval between blocked sessions versus allowed sessions.

Percentage of Blocked
Sessions to Allowed
Sessions

20
30
50
60
80

The SIP-Digits Format is used by several parameters, as described above, which include digits as part of their content. This format provides information on the Nature of Number, the Numbering Plan and Presentation Restriction Indicator. In an embodiment, the SIP-Digits Format can include the following information and/or formats:

Digits: A digit string of 1 to 20 integers.

Nature of Number for Charge Number:
0 = Spare
1 = ANI of the calling party; subscriber number
2 = ANI not available or provided
3 = ANI of the calling party, national number
4 = Spare
5 = ANI of the called party included; subscriber number
6 = ANI of the called party; not included
7 = ANI of the called party included; national number

Nature of Number for Primary and Alternate Routing Parameters and Manipulated Digits Parameters:

| Nature of Number for Primary and Alternate Routing | |
|---|---|
| Parameters and Manipulated Digits Parameters: | |
| 0 = | Not Applicable |
| 1 = | Subscriber |
| 2 = | Spare |
| 3 = | National, significant |
| 4 = | International |
| 5 to 224 = | Spare |
| 225 = | Subscriber, operator requested |
| 226 = | National, operator requested |
| 227 = | International, operator requested |
| Nature of Number for Calling Party Address Parameter: | |
| 0 = | Unknown or not applicable, default |
| 1 = | Unique subscriber number |
| 2 = | Spare |
| 3 = | Unique national (significant) number |
| 4 = | Unique international number |
| 5 to 224 | Spare |
| 225 = | Non-unique subscriber number |
| 226 = | Spare |
| 227 = | Non-unique national number |
| 228 = | Non-unique international number |

Numbering Plan for Calling Party Address, Primary and Alternate Routing Addresses, and Charge Number, Manipulated Digits parameters:

| Numbering Plan for Calling Party Address, Primary and Alternate | |
|---|---|
| Routing Addresses, and Charge Number, | |
| Maniplated Digits parameters: | |
| 0 = | Unknown or not applicable |
| 1 = | ISDN Numbering Plan (E.164) |
| 2 to 4 = | Reserved |
| 5 = | Private |
| Presentation Restriction Indicator: | |
| 0 = | Presentation Allowed |
| 1 = | Presentation restricted (default) |
| 2 = | Number unavailable |
| Screening Indicator: | |
| 0 = | Reserved for user provided, not screened or spare |
| 1 = | User provided, passed network screening |
| 2 = | Reserved for user provided, failed network screening |
| 3 = | Network provided. |

Below in Table 1, shown is a Unique Boundary Field List, which includes a number of fields that are populated by core network elements (e.g. the CCE 24) into the INVITE and/or Redirect message with a few exceptions.

TABLE 1
Unique Boundary Field List

| Filed | Name |
|---|---|
| BEID = | Border Element ID |
| CN = | Charge Number (a.k.a. ANI) |
| CID = | Customer ID |
| L = | LATA |
| C = | Carrier |
| CU = | Carrier Usage |
| CPN = | Calling Party Number |
| CN = | Caller Name |
| CPST = | Charge Party Station Type |
| CA = | Collected Address (a.k.a. Dialed Number) |
| TQ = | Test Query |
| PRA = | Primary Routing Address |
| ARA = | Alternate Routing Address(es) |
| ARC = | Alternate Routing Condition |
| MD = | Manipulated Digits |
| INS = | Recording Instructions |
| INF = | Recording Information |
| TID = | Transaction ID |
| ED = | Error Description |
| SG = | Session Gapping |

It should be understood that the components and/or information included in the above-described SIP INVITE and SIP Redirect messages can be incorporated into a plurality of other SIP messages, such as a SIP INFO message, employed for processing requests for multi-media services.

While various features of the present invention are described herein in conjunction with exemplary embodiments having various components using a number of protocols, it should be understood that other suitable components and protocols can be used without departing from the present invention.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto. All references and publications cited herein are expressly incorporated herein by reference in their entirety.

What is claimed is:

1. A method of forming a multi-media communication path between at least a calling communication device and at least a destination communication device, the method comprising:
receiving a request for a multi-media service at a multi-media provider system;
processing the call request at the multi-media provider system for generating a Session Initiation Protocol (SIP) INVITE message; and
sending the SIP INVITE message to at least one processor of the multi-media provider system for processing the request for the multi-media service, wherein the SIP INVITE message includes at least one body portion having at least one information element required for providing call processing and service processing for the request for the multi-media service.

2. The method of claim 1, wherein processing the call request at the multi-media provider system includes processing the call request at a border element located on the multi-media provider system.

3. The method of claim 1, wherein processing the call request at the multi-media provider system includes processing the call request at a call control element located on the multi-media provider system.

4. The method of claim 3, wherein generating the SIP INVITE message includes providing border element identifier information in the at least one body portion of the SIP INVITE message.

5. The method of claim 4, wherein generating the SIP INVITE message includes providing charge number related information in the at least one body portion of the SIP INVITE message.

6. The method of claim 5, wherein generating the SIP INVITE message includes providing local access and transport area related information in the at least one body portion of the SIP INVITE message.

7. The method of claim 6, wherein generating the SIP INVITE message includes providing carrier related information in the at least one body portion of the SIP INVITE message.

8. The method of claim 7, wherein generating the SIP INVITE message includes providing calling party number related information in the at least one body portion of the SIP INVITE message.

9. The method of claim 8, wherein generating the SIP INVITE message includes providing charge party station type related information in the at least one body portion of the SIP INVITE message.

10 The method of claim 9, wherein generating the SIP INVITE message includes providing Customer Identifier related information in the at least one body portion of the SIP INVITE message.

11. The method of claim 10, wherein generating the SIP INVITE message includes providing collected address related information in the at least one body portion of the SIP INVITE message.

12. The method of claim 11, further including:
processing the SIP INVITE message at the processor for generating a SIP Redirect message; and
sending the SIP Redirect message to the call control element, wherein the SIP Redirect message includes at least one body portion having at least one information element required for providing call processing and service processing of the multi-media service request.

13. The method of claim 12, wherein generating the SIP Redirect message includes providing a collected address parameter in the at least one body portion of the SIP Redirect message.

14. The method of claim 13, wherein generating the SIP Redirect message includes providing a primary routing address parameter in the at least one body portion of the SIP Redirect message.

15. The method of claim 14, wherein generating the SIP Redirect message includes providing an alternate routing address parameter in the at least one body portion of the SIP Redirect message.

16. The method of claim 15, wherein generating the SIP Redirect message includes providing an alternate routing condition parameter in the at least one body portion of the SIP Redirect message.

17. The method of claim 16, wherein generating the SIP Redirect message includes providing a manipulated digits parameter in the at least one body portion of the SIP Redirect message.

18. The method of claim 17, wherein generating the SIP Redirect message includes providing a Carrier Identification Code parameter in the at least one body portion of the SIP Redirect message.

19. The method of claim 18, wherein generating the SIP Redirect message includes providing a Carrier Usage parameter in the at least one body portion of the SIP Redirect message.

20. The method of claim 19, wherein generating the SIP Redirect message includes providing a recording instruction parameter in the at least one body portion of the SIP Redirect message.

21. The method of claim 20, wherein generating the SIP Redirect message includes providing a recording information parameter in the at least one body portion of the SIP Redirect message.

22. A Session Initiation Protocol (SIP) message adapted for communication between a plurality of network elements to form a multi-media communication path between at least a calling communication device and at least a destination communication device, the SIP message comprising:
a header portion; and
a body portion, wherein the body portion includes at least one information element required for providing call processing and service processing for at least one request for at least one multi-media service.

23. The SIP message of claim 22, wherein the body portion further includes border element identifier information.

24. The SIP message of claim 23, wherein the body portion further includes charge number related information.

25. The SIP message of claim 24, wherein the body portion further includes local access and transport area related information.

26. The SIP message of claim 25, wherein the body portion further includes carrier related information.

27. The SIP message of claim 26, wherein the body portion further includes calling party number related information.

28. The SIP message of claim 27, wherein the body portion further includes charge party station type related information.

29. The SIP message of claim 28, wherein the body portion further includes collected address related information.

30. The SIP message of claim 29, wherein the body portion further includes Customer Identifier parameter.

31. The SIP message of claim 30, wherein the body portion further includes a Test Query parameter.

32. The SIP message of claim 31, comprising a SIP INVITE message.

33. The SIP message of claim 22, wherein the body portion further includes a collected address parameter.

34. The SIP message of claim 33, wherein the body portion further includes a primary routing address parameter.

35. The SIP message of claim 34, wherein the body portion further includes an alternate routing address parameter.

36. The SIP message of claim 35, wherein the body portion further includes an alternate routing condition parameter.

37. The SIP message of claim 36, wherein the body portion further includes a manipulated digits parameter.

38. The SIP message of claim 37, wherein the body portion further includes a Carrier Identification Code parameter.

39. The SIP message of claim 38, wherein the body portion further includes a Carrier Usage parameter.

40. The SIP message of claim 39, wherein the body portion further includes a recording instruction parameter.

41. The SIP message of claim 40, wherein the body portion further includes a recording information parameter.

42. The SIP message of claim 41, wherein the body portion further includes a Session Gapping parameter.

43. The SIP message of claim 42, wherein the body portion further includes a Error Description parameter.

44. The SIP message of claim 43, comprising a SIP Redirect message.
